(19) United States
(12) Patent Application Publication
(10) Pub. No.: US 2003/0084439 A1
(43) Pub. Date: May 1, 2003

(54) Incentive system for distributing software over a computer network

(76) Inventors: Ross Perkins, Seattle, WA (US); Shawn Boday, Seattle, WA (US)

Correspondence Address: David A. Hall, Heller Ehrman White & McAuliffe LLP, 7th Floor, 4350 La Jolla Village Drive, San Diego, CA, 92122-1246, US

(21) Appl. No.: 10/265,514

(22) Filed: Oct. 4, 2002

Related U.S. Application Data
(60) Provisional application No. 60/327,469, filed on Oct. 4, 2001.

(51) Int. Cl. G06F 9/445; G06F 9/44

(52) U.S. Cl. 717/177; 717/173; 717/178

(57) ABSTRACT

A computer network is used to distribute software and a user is provided with non-monetary incentive to download and install the software. Electronic content is offered as an incentive for installing software on a client device. The electronic content may be offered using a Web page that includes a hyperlink that a user can select to request the content. When a server device receives a request from a client device to download the content from to the client device, the server device verifies that the software is installed on the client device. The server device then downloads the requested content to the client device if the software is installed on the client device.

### REFERENCE TO PRIORITY APPLICATION

This application claims priority of co-pending U.S. Provisional Patent Application Serial No. 60/327,469 entitled “Incentive System For Distributing Software Over A Computer Network”, filed Oct. 4, 2001. Priority of the filing date of Oct. 4, 2001 is hereby claimed, and the disclosure of said Provisional Patent Application is hereby incorporated by reference in its entirety.

### BACKGROUND OF THE INVENTION

1. Field of the Invention

This invention relates generally to electronic distribution of software, and more particularly to a payment and incentive mechanism for the electronic distribution of software.

2. Description of the Related Art

The success or failure of many software development companies that distribute software over the Internet often depends on whether they can successfully convince a vast base of users to download and use their software. However, as the quantity of software programs available over the Internet increases, the average user can be more selective in choosing which software programs to download. This makes it increasingly difficult for software development companies to convince users to download their particular software.

Moreover, to the dismay of many software development companies, many users are becoming less willing to pay money for the downloading and use of new software programs over the Internet. This is at least partially the result of the growing popularity of “shareware” and, in particular, “freeware”. Shareware is software that is distributed free on a trial basis with the understanding that the user may need or want to pay money for it later. Freeware is software that is unconditionally offered at no monetary cost to the user. As a result of the increasing availability of sophisticated shareware and freeware software programs, many users avoid downloading any software that requires them to pay money to a vendor in exchange for use of the software.

Making matters worse for software development companies, a growing number of computer users are refraining from downloading and installing any software on their computers, regardless of whether downloading the software is free or requires a monetary fee. The reasons that such users are resistant to downloading software over the Internet can vary. Some users are just satisfied with the vast collection of software that is often installed by default on an operating system or computer hardware system. Other users are inexperienced when it comes to downloading and installing software over the Internet and would rather avoid the “hassle” of the software download and install processes. In other cases, users are simply lazy or too busy and just never get around to performing the actual download process, even though they would like to download software. Regardless of the reasons, the bottom line is that many computer users are resistant to downloading software over the Internet.

Consequently, it can be very difficult and expensive for software vendors to attracting users to download new software. Given that many users are unwilling to pay money for downloaded software, it is increasingly problematic for software vendors and developers to recoup the marketing costs that can be associated with enticing users to download and try-out a software program over the Internet.

In view of the foregoing, there is a need for a system of providing incentive to a user to download software over the Internet and enabling the user to easily download and install the software on a computer.

### SUMMARY

In accordance with the invention, a computer network is used to distribute software and a user is provided with non-monetary incentive to download and install the software. Access to electronic content is offered as an incentive for installing software (the “required software”) on a client device. The electronic content may be offered via a Web page that includes a hyperlink that a user can select to request the content. When a server device receives a request from a client device to download the content to the client device, the server device verifies that the required software is installed on the client device. If the required software is installed on the client device, the server device then downloads the requested content to the client device. If the required software is not installed on the client device, then the required software is first installed on the client device before the content is downloaded to the client device.

Software and content providers can use the disclosed method and system to distribute their software and content cheaply to an unlimited number of users. To offer the users incentive to install the software, software vendors grant the users access to content—such as content for which the user would ordinarily have to pay. The content is not necessarily dependent upon the required software for the user to process it. Rather, the content serves as an enticement for the user to install the required software. The vendor's grant of access to the content is “payment” to the user for installing the required software. Thus, in addition to the required software, the user obtains additional value for having installed the required software, in the form of content of one form or another. Moreover, the content provider can use the disclosed system and method in distributing content to users.

Likewise, the user's use of the required software is “payment” to the vendor for the software, and for grant of access to the restricted content. The benefit to the user is that “payment” does not result in any negative cash flow (unless the installed software somehow causes this situation). The required software could allow the vendor to provide some service for the user or for business partners on an ongoing basis after the initial install.

Other features and advantages of the present invention should be apparent from the following description of the preferred embodiment, which illustrates, by way of example, the principles of the invention.

### BRIEF DESCRIPTION OF THE DRAWINGS

FIG. 1 is a flow diagram that shows the operations performed in downloading software and content in accordance with the invention.

FIG. 2 is a block diagram of a computer network in which the operations shown in FIG. 1 may be implemented in accordance with the invention.

FIG. 3 shows a screen shot on a computer of the FIG. 2 network, illustrating an exemplary Web page that can be used to download software in accordance with the invention.

FIG. 4 shows an exemplary window that contains text that requests user permission to install the required software.

FIG. 5 shows an exemplary window that contains text that again requests user permission to install the required software.

FIG. 6 is a block diagram of a computer device that is a node of the computer network of FIG. 2.

### DETAILED DESCRIPTION

Disclosed is a method and system for distributing one or more software programs via a computer network, such as the Internet. The system provides an incentive for a user to download the software program, the incentive being in the form of electronic content that is provided to the user in exchange for the user installing a software program (the “Required Software”) on the user's computer. In this manner, the user's downloading and installation of the software enables the user to “pay” a software provider for the electronic content without expending any monetary resources as part of the payment. The software provider's offering of the content is an incentive to the user to install the Required Software on the user's computer.

In one embodiment, the incentive is provided to the user in the form of one or more content offerings, wherein user access to the content depends upon the installation of the Required Software on the user's computer, which is a client machine on a computer network. User access to the content is not granted unless the user installs the Required Software on the user's computer. In order to receive such content, the user executes an Installer Application that checks to ensure that the Required Software is present on the client machine. The content can be in the form of audio or video files, such as movie or music files, compressed files, such as collections of content, or in any other downloadable form.

If the Required Software is not present on the client machine, the Installer Application denies the user access to the content until such time as the Required Software has been installed. In this circumstance, in lieu of providing access to the content, the installer application can prompt the user, requesting permission to install the Required Software. Upon the user's consent, the Required Software is downloaded from a server system, such as via Hyper-Text Transfer Protocol (HTTP) or File Transfer Protocol (FTP), and installed onto the user's client machine. Once the software is on the client machine, the user is granted access to the restricted content.

Authentication can be performed in a variety of ways. One embodiment uses a custom User-Agent header of an HTTP message sent from the client to the server when requesting the restricted content. This User-Agent header sufficiently differentiates the request from any widely available WWW browsers, serving to identify and authenticate the request, so content is reasonably secure in most circumstances. Depending on the nature of the content, its sensitivity and the likelihood of content theft, additional security measures can easily be integrated with this process.

Process Overview

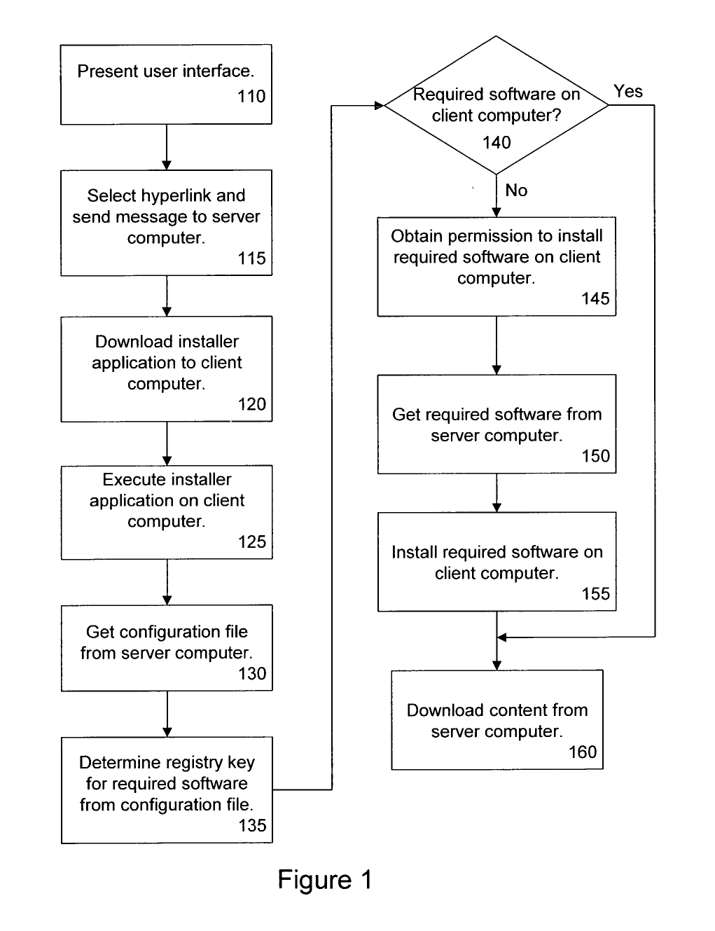

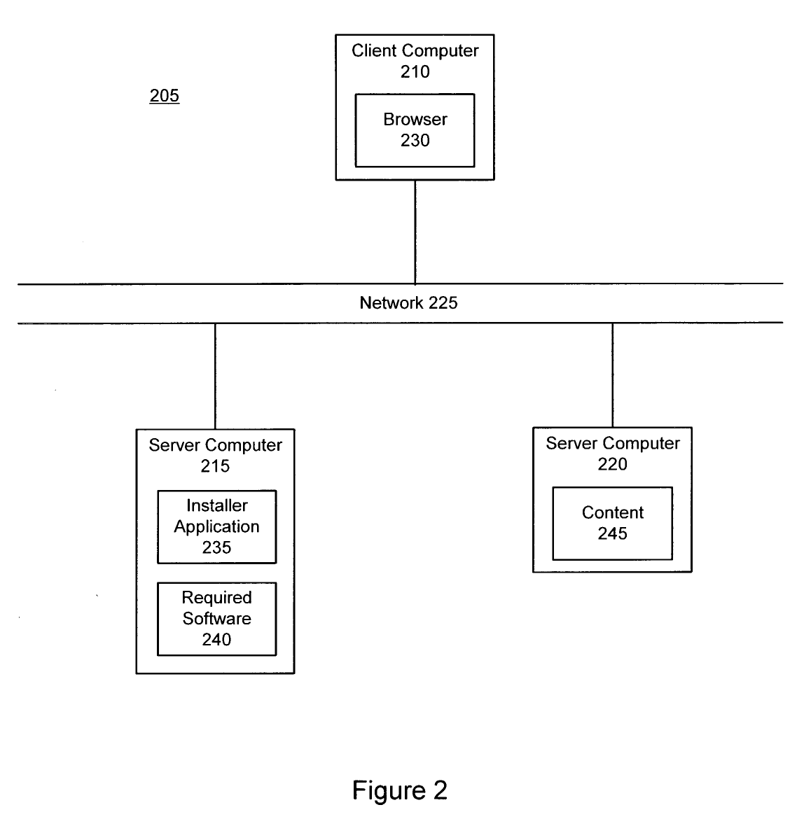

FIG. 1 is a flow diagram that describes the operations performed in accordance with the present invention. In the first operation, represented by the flow diagram box numbered 110, a user of a client computer 210 (shown in FIG. 2) is presented with a user interface that offers electronic Content 245 (shown in FIG. 2) to the user. The user interface can be presented to the user via a hyperlink in a Web browser window displayed on the user's client computer 210.

As shown in FIG. 2, the client computer 210 is part of a computer network system 205, which includes the client computer 210, a first server computer 215, and a second server computer 220, all of which are nodes of a computer network 225, such as the Internet. A browser application 230 resides in memory of the client computer 210. The first server computer 215 contains the Installer Application 235 and the Required Software 240, which can both be downloaded to the client computer 210 over the network 225. The second server computer 220 includes the Content 245, which can be any type of electronic content that can be transmitted to the client computer 210 over the network 225. The Content 245 can be, for example, digital audio files, digital graphic files (including animation and movie files), as well as electronic data that is streamed to the client computer 210. It should be appreciated that the Installer Application 235, Required Software 240, and Content 245 can all reside on the same server computer, or they could be distributed among any number of server computers, such as shown in FIG. 2.

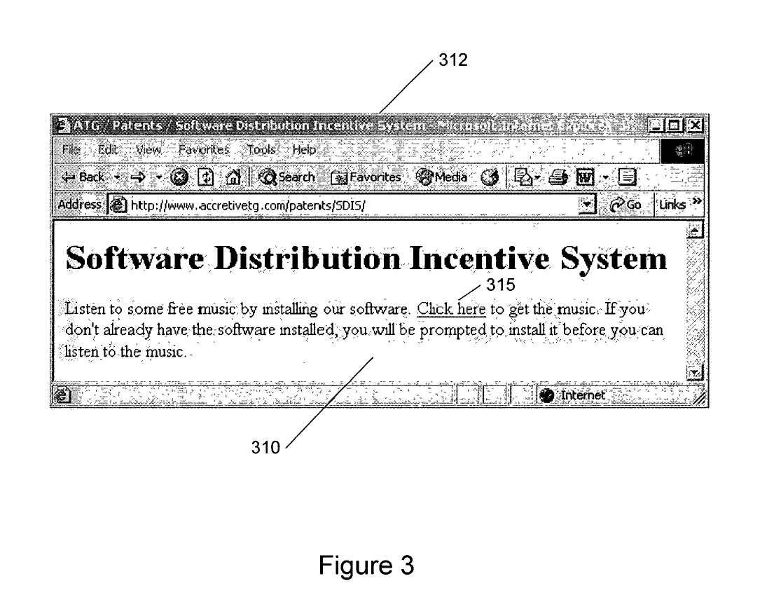

As mentioned, in the operation of flow diagram box 110 of FIG. 1, the user is presented with a user interface that offers the Content 245 to the user. The user interface can be in the form of a Web page that is displayed in a browser window on the client computer 230. The Web page can be downloaded to the client computer 210 from the server computer 215 over the network 225 in a well-known manner. FIG. 3 shows an exemplary Web page 310 contained in a browser window 312. The Web page 310 that contains a hyperlink 315 that the user can select to request the Content 245.

In the next operation, represented by the flow diagram box numbered 115, the user clicks on the hyperlink 315 on the Web page 310, which results in the client computer 210 sending a message to the server computer 215 over the network 225. The message contains a request to the server computer 215 to provide the client computer 210 with the Installer Application 235, which will install the Required Software on the client computer 210, as described further below. Selection of the hyperlink 315 can result in the client computer 210 sending an HTTP message to the server computer 215, such as an HTTP message that contains identifying information regarding the client computer 210 and the browser application 230 on the client computer 210. The HTTP message can contain a string that references the location of one or more executable files that will be used to download the Installer Application and initiate the process. An exemplary HTTP string is:

http://www.accretivetg.com/patents/SDIS/Get_Music.exe

In the next operation, the browser application 230 of the client computer 210 downloads the Installer Application 235 over the network 225 from the server computer 215, as represented by the flow diagram box numbered 120. This occurs as a result of the selection of the hyperlink 315. Prior to downloading the Installer Application 235, the browser application 230 can check local memory, such as a local cache, to determine whether the browser application already resides in the client computer 210. If it is determined that the client computer already contains the Installer application 235, then the operation represented by the flow diagram box 120 need not be performed.

In the next operation, the Installer Application 235 executes on the client computer 210, as represented by the flow diagram box numbered 125. The execution of the Installer Application transfers process control to the Installer Application 235. The Installer Application 235 can be invoked automatically when the hyperlink of the Web page 310 is selected, such as via any available technology, including JavaScript, “ActiveX”, or some other similar technology. The operation of the Installer Application 235 will be described with respect to the “Windows” operating system, available from Microsoft Corporation. It should be understood, however, that the Installer Application 235 can be configured by those skilled in the art to operate in conjunction with other operating systems, such as “Linux” and “Macintosh”.

When executing, the Installer Application 235 can be configured to coordinate with the server computer 215 and/or the server computer 220 in order to uniquely identify the client computer 210, such as to provide information regarding the client computer hardware setup or software setup. In this regard, the Installer Application 235 can cause the client computer 210 to send one or more HTTP messages to the server computer 215 or the server computer 220 over the network 225. The Installer Application 235 can store a unique identifier on the client computer 210 which can be used to track the client computer's interaction with the server computer 215. The tracked information can be periodically sent to the server computer 215 and used to build a user profile of the types of content a user likes to download.

In the next operation, represented by the flow diagram box numbered 130, the Installer Application 235 causes the client computer 210 to download a configuration file from the server computer 215. The configuration file includes a definition of the Required Software 240 and the Content 245. The definition can include, for example, one or more uniform resource locators (URLs) that designate a network location for the Required Software 240 and the Content 245, as well as information that can be used to verify that the Required Software is installed on the client computer 210. Thus, the configuration file can include, for example:

A uniform resource locator (URL) for the Required Software 240.

A URL of the Content 245.

A message to be displayed for the user asking whether the user wants to install the software.

Text for one or more messages to be displayed for the user inquiring whether the user will provide permission to install the Required Software 240 on the client computer 210.

The Registry ID that will be linked with the Required Software 240 in the registry of the client computer 210.

In a Microsoft Windows environment, the configuration file can be in the form of an .INI text file, such as the following exemplary .INI file:

[INSTALL-URL]

http://download.com/application.exe

[CONTENT-URL]

http://content.com/music.mp3

[CONTENT-ID]

APPLICATION-0001

[CONFIRMATION1]

To install necessary software and listen to music, click the “Yes” button below.

The music is bundled with software that will [explanation of software].

Would you like to install the software and listen the music?

[CONFIRMATION2]

DID YOU KNOW—software advertising Would you like to install the software and get access to the music?

In the above exemplary .INI file, the [INSTALL-URL] field identifier is followed by text that contains the URL that can be used to access the Required Software or to access a setup program associated with the Required Software. The [CONTENT-URL] field identifier is followed by text that contains the URL that can be used to access the Content 245. The [CONTENT-ID] field identifier is followed by text that identifies a registry record that can be inserted into the client computer's registry to record that the Required Software has been installed on the client computer 210. The [CONFIRMATION1] and [CONFIRMATION2] fields contain text that can be processed by the Installer Application 235 and used in message prompts to the user during the installation process. It should be appreciated that the server computer 215 can download the configuration file in parallel with the downloading of the Installer application 235, rather downloading the configuration file after the Installer application 235 has been downloaded.

In the next operation, the Installer Application 235 determines the Windows registry key of the Required Software 240 using the previously-obtained configuration file, as represented by the flow diagram box numbered 135. The Installer Application can obtain the registry key of the Required Software 240, for example, by examining the [CONTENT-ID] field of the configuration file described above.

In the next operation, represented by the decision box numbered 140, the Installer Application 235 checks the client computer 210 to determine whether the Required Software 240 (as defined in the configuration file) is installed on the client computer 210. In one embodiment, the Installer Application 235 performs a search of the client computer hard drive for the presence of a particular file, such as an executable file, that is representative of the Required Software 240. For example, the Installer application 235 can query the file system of the client computer 210 to check for the presence of the file. Alternately, or in addition to, checking for the file, the Installer Application 235 can examine the registry of the client computer 210 for a registry key that indicates that the Required Software 240 is installed on the client computer 210. The registry key was previously obtained from the configuration file.

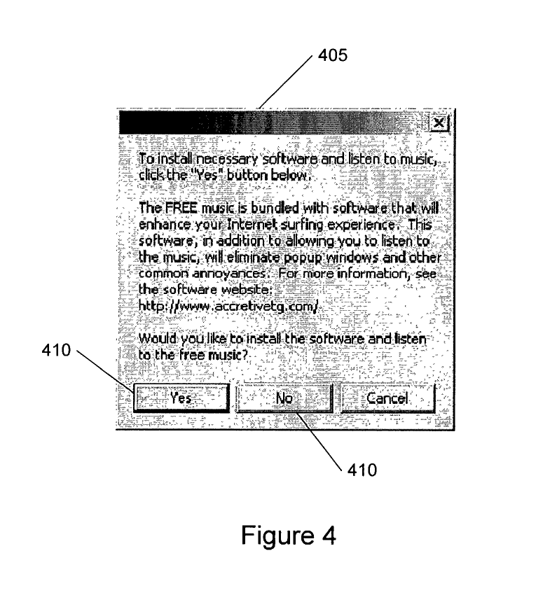

If the Installer Application determines that the Required Software 240 is not present on the client computer 210 (a “No” result from the decision box numbered 140), then the Installer Application 235 requests permission from the user of the client computer 210 to install the Required Software 240. This operation is represented by the flow diagram box numbered 145. The process by which the user is requested to give permission to install the Required Software 240 can vary. For example, the Installer Application 235 can cause a window to be displayed on the client computer 210, wherein the window contains text that requests permission. For example, the text can be text that the Installer Application 235 obtains from the configuration file. Alternately, the text can be received as an HTML file from the server computer 215 via an HTTP message over the network 225. This would enable hyperlinks to be included in the message. FIG. 4 shows an exemplary window 405 that contains text that requests user permission to install the Required Software 240. The Installer Application 235 obtains the text for the window 405 by referencing the [CONFIRMATION1] field of the configuration file. The window can also contain one or more hyperlink buttons 410 that the user can select to grant or deny permission.

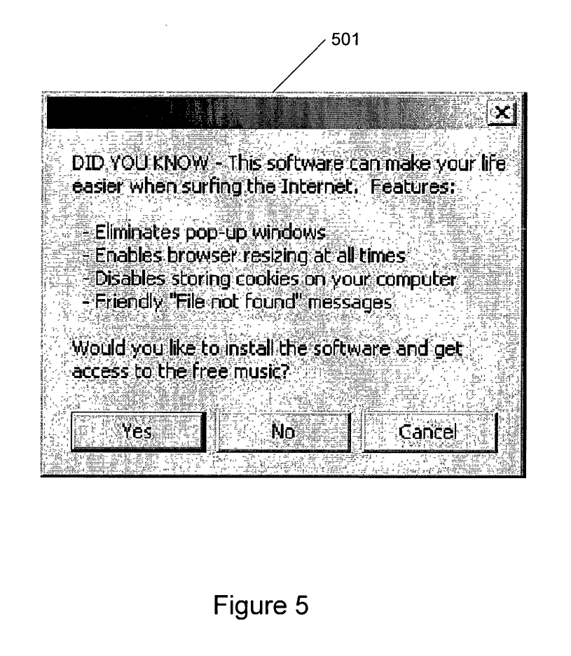

With reference still to the operation represented by flow diagram box numbered 145 in FIG. 1, the user might not give permission to the Installer Application 235 to install the Required Software 240. For example, the user could have clicked on the “No” box in the window 405 of FIG. 4. In such a situation, the Installer Application 235 terminates. Prior to termination, the Installer Application 235 can transmit information to a network location, such as a server computer associated with a vendor of the Installer Application. For example, the Installer Application 235 can report a non-installation, a successful installations, or any other information. Furthermore, if the user does not grant permission, the Installer Application 240 can cause a second window to appear on the client computer 210 that again asks for permission and explains that the user will not be able to download the Content 245 until permission is granted to install the Required Software. The window can also contain information that explains advantages of installing the Required Software, such as the window 501 shown in FIG. 5.

If the user has permitted the Installer Application 235 to install the Required Software 240 on the client machine 210, the Installer Application 235 downloads the Required Application 240 from the server computer 215 (or from another network location specified in the configuration file). This is represented by the flow diagram box numbered 150. Alternately, the Installer Application can download a setup file for the Required Application, wherein the setup file is an executable file that, when executed, will cause the client computer 210 to download the Required Application 240. The Installer Application 235 downloads the Required Application 240 (or the setup program) by sending an HTTP message to the server computer 215, wherein the HTTP message requests the server computer 215 to transmit the Required Application 240 to the client computer 210.

It should be appreciated that whenever software or content is downloaded from any of the server computers, the software or content can be cached on the client computer 110 unless the specific content demands otherwise. It is possible that the Installer Application 235 will run multiple times and caching previous downloads will limit the computational and network expense of transferring files to the client computer 210.

In the next operation, represented by the flow diagram box numbered 155, the Installer Application 235 installs the Required Software 240 on the client computer 210. The installation of the Required Software 240 can be performed transparent to the user in that the installation process does not require user assistance. For example, the Installer Application 235 can automatically store any Required Software 240 files on the client computer 210, or the Installer Application 235 can automatically cause a setup program to run.

In any event, after the Required Software 240 is installed, the Installer Application 235 creates a registry key for the Required Software in the registry of the client computer 210. This can later be used to verify installation of the Required Software 240 on the client machine 210. After installation of the Required Software 240, the Installer Application can later check to ensure that the Required Software 240 has been installed successfully, such as by examining the registry or by searching for a file associated with the Required Software. If the Installer Application determines that the Required Software failed to install successfully, the Installer Application can records an error and terminates, or the Installer Application can notify the server computer 215 of the installation error.

After the Installer Application 235 verifies that the Required Software 240 is installed on the client computer 210, the Installer Application 235 proceeds to cause the client device 210 to download the Content 245 from a network location, as represented by the flow diagram box numbered 160. For example, the client device 210 can automatically download the Content 245 from the server computer 215, which is the same server computer that provided the Installer Application. Alternately, the Content 245 can be downloaded from a separate server computer, such as the server computer 220 in FIG. 2. In another embodiment, the Installer Application 235 automatically directs the browser application 230 to a network server where the Content 245 can be obtained. In any event, the Installer Application use the configuration file to obtain the network location from which the Content 245 will be downloaded.

Pursuant to downloading of the Content 245, the Installer Application 235 will cause the client computer 210 to communicate with a network server, such as the server computer 220, that can serve the content to the client computer 210. The Installer Application 235 causes the client computer to send an HTTP message to the server computer 220. The HTTP message contains an authentication code, such as a unique User-Agent header, that the server computer 220 can use to verify that the client computer 210 is authorized to access the Content 245.

The user is then free to access the Content 245. The access can be limited. For example, the Installer Application 235 can transfer process control to a content viewer software application (which can reside on the client computer 210) that provides access to the Content 245 under control of the Installer Application 235. In another embodiment, the Installer Application 235 automatically deletes the Content 245 from the client computer 210 after the user has viewed the Content 245. This prevents the user from deleting the Required Software and viewing the content through third party viewing software. It should be appreciated that the Required Software 240 need not be related to the client computer's ability to view or use the Content 245. For example, the Required Software 240 can be a browser plug-in that enables the client computer browser application to limit pop-up windows, while the Content 245 can be a digital music file that is played using an MPEG player. Thus, the Required Software 240 is “required” in the sense that it must be installed on the client computer 210 as a requirement for the Installer Application 235 to proceed with downloading the Content 245. The functionality of the Required Software 240 need not be related to viewing or using the Content 245.

Exemplary Embodiment

There is now described an example of software distribution in accordance with the invention. Pursuant to the example, suppose that Software Vendor A is the distributor of the Required Software, which comprises a free web browser plug-in software that offers the following features to users who install it in a Web browser, such as the “MS Internet Explorer” or “Netscape Navigator” browsers:

Suppresses pop-up windows.

Gives the user full control of window sizing, scrolling, etc, even when the Web page the user is visiting tries to limit this control.

Makes all HTTP cookies “session-only”, so Web sites cannot store data on the user's machine for more than the current session.

Causes the browser to use a specialized search engine, run by Vendor A, by which Vendor A may profit from searches performed.

Thus, the plug-in software contains beneficial features for any user who spends a lot of time on the Internet. Additionally, the plug-in software contains a mechanism for Vendor A to make revenue from the distribution of the software, so any user who downloads the plug-in software can “pay” for the software simply by using it. There is no monetary expense to the user; rather advertisers pay the Vendor for exposure to Vendor A's user-base.

Vendor A can offer the plug-in software at a Web site, for example, a music store Web site. Users at the music store Web site likely want to obtain music, and probably would prefer to not pay for it. Now suppose that Vendor A and the music store that operates the Web site decide to partner and distribute Vendor A's software. Vendor A and the music store can use the software processes described herein to implement the partnership and distribution of Vendor A's software.

For example, the Music store can place a link on the music store's Web site, wherein the link offers a free music download of any CD in the store, in exchange for installing the software plug-in software. In this case, the link would correspond to the link 315 that is shown on the exemplary Web page of FIG. 3. A user who selects the link will initiate a process that automatically downloads and runs an Installer Application, such as the process that was described above with reference to the flow diagram of FIG. 1. The Installer Application then downloads a configuration file from a server computer, such as a server computer operated by Vendor A or the music store. As mentioned, the configuration file specifies, for example, the name/location of the Required Software (the plug-in software), the name/location of the content (the music files) that is offered as a benefit to installing, and any other data the Installer Application will need in order to run.

Once downloaded onto the user's computer, the Installer Application checks to see if the Required Software (which in this example is the previously-discussed plug-in program) is installed on the user's client computer. Once the installation of the Required Software is verified, the Installer Application will grant access to the content, which can comprise, for example, digital music files. If the Required Software is not installed on the user's computer, the Installer Application prompts the user for permission to install it. Upon the user's approval, the Installer Application downloads the Required Software's setup program based on the configuration file, and installs the Required Software on the user's computer. Once the Required Software has been successfully installed, the user is granted access to the Web site where the digital music files are located. The user's computer is then granted access to download the content at no charge.

The Music store can provide other options on its Web site, such as the option to purchase other music files for a small fee. It should be appreciated that any number of additional options are possible in this scenario.

It should be appreciated that in this case, the Required Software (the browser plug-in offered by Vendor A) is in no way related to the user's ability to view or use the content (the Music store's digital music). The sense in which the Required Software is “required” for utilizing the downloaded music content is that the user cannot download the digital music for free unless the user installs the Required Software on the user's computer. The Required Software is not “required” to download and listen to the digital music. This differentiates the process of downloading the Required Software and receiving the Content from the process of downloading software such as Adobe “Acrobat Reader” in order to view an Adobe “Acrobat” document. In that case, the Acrobat Reader is required for a computer to render a document for viewing. In the case of Vendor A's software, the Required Software is entirely unrelated to the content being offered as incentive to the user (though it is not necessarily required to be completely unrelated).

Installer Application

In accordance with one aspect of the invention, the Installer Application can be an application that verifies that the client computer 210 has certain software installed before granting the client computer 210 with access to the content 245.

The Installer Application can be an executable file. The Installer Application is associated with a configuration file (such as a .INI file in the case of the Microsoft Corporation “Windows” operating system) that can be made available from a public server, such as a server that operates according to HTTP. Some options of the INI file are discussed below. As discussed above with reference to the flow diagram of FIG. 1, the Installer Application follows the following processes upon downloading onto a client computer:

1. The Installer Application downloads the configuration file (such as the.INI file) from a network location.

2. If the Required Software has not yet been installed on the client computer:

a. The Installer Application prompts the user with a custom message asking whether the user wants to install the Required Software on his computer.

b. The user then has the following options:

i. Grant permission to install the Required Software—the Installer Application then installs the software on the computer, and the process proceeds to #2c, below.

ii. Do not grant permission to install the Required Software the Installer Application then causes a message to be displayed, wherein the message explains that the user's computer does not have the Required Software. The message can also ask again if the user would like to install the Required Software. The user can then either:

1. Grant permission to install the Required Software, and the process proceeds to #2c.

2. Do not grant permission to install the Required Software, and the process terminates.

iii. Alternately, the process can be manually cancelled by the user.

c. After the user grants permission, the Installer Application causes the user's computer to download the Required Software from a network location, such as a location specified in a uniform resource locator.

i. If the download fails, the Installer Application can display an error condition indicator, such as a window with text that indicates to the user that an error has occurred. The Installer Application can then terminate.

d. The Installer Application then installs the Required Software and verifies that the install succeeded.

i. If the installation failed, the Installer Application can provide an error indication and send the indication to a network location, and then terminate.

ii. If the installation succeeded, the Installer Application can save on the computer a record that memorializes the successful installation.

3. Only if the software is currently installed, the Installer Application performs the following processes:

a. If the content is not present on the user's computer:

i. The Installer Application causes the computer to download the content from a server computer on the network.

1. If this fails, the Installer Application shows some type of error indication and terminates.

ii. The Installer Application can cache the restricted content on a local hard drive to save bandwidth in the future by eliminating the need for any future downloads of the restricted content.

b. The Installer Application can open the restricted content with the default viewer for that MIME or file type.

The Installer Application preferably ensures that the user has an Internet connection when executing.

Exemplary Computer

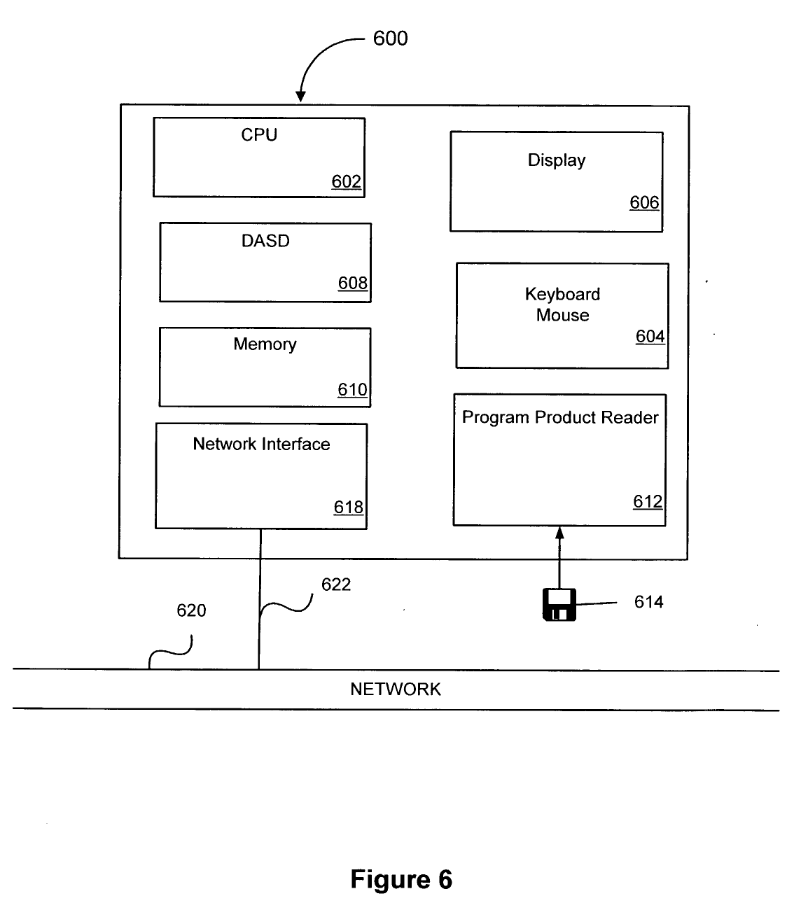

FIG. 6 is a block diagram of a computer in the system 205 of FIG. 2, illustrating the hardware components included in one of the computers. Those skilled in the art will appreciate that the devices 210 and 220 may all have a similar computer construction, or may have alternative constructions consistent with the capabilities described herein.

FIG. 6 shows an exemplary computer 600 such as might comprise any of the devices 210, 215 or 220. Each computer 600 operates under control of a central processor unit (CPU) 602, such as a “Pentium” microprocessor and associated integrated circuit chips, available from Intel Corporation of Santa Clara, Calif., USA. A computer user can input commands and data from a keyboard and computer mouse 604, and can view inputs and computer output at a display 606. The display is typically a video monitor or flat panel display. The computer 600 also includes a direct access storage device (DASD) 608, such as a hard disk drive. The memory 610 typically comprises volatile semiconductor random access memory (RAM). Each computer preferably includes a program product reader 612 that accepts a program product storage device 614, from which the program product reader can read data (and to which it can optionally write data). The program product reader can comprise, for example, a disk drive, and the program product storage device can comprise removable storage media such as a magnetic floppy disk, a CD-R disc, a CD-RW disc, or DVD disc.

Each computer 600 can communicate with the others over a computer network 620 (such as the Internet or an intranet) through a network interface 618 that enables communication over a connection 622 between the network 620 and the computer. The network interface 618 typically comprises, for example, a Network Interface Card (NIC) or a modem that permits communications over a variety of networks.

The CPU 602 operates under control of programming steps that are temporarily stored in the memory 610 of the computer 600. When the programming steps are executed, the computer performs its functions. Thus, the programming steps implement the functionality of the processes described above, such as the functionality of the Installer Application. The programming steps can be received from the DASD 608, through the program product storage device 614, or through the network connection 622. The program product storage drive 612 can receive a program product 614, read programming steps recorded thereon, and transfer the programming steps into the memory 610 for execution by the CPU 602. As noted above, the program product storage device can comprise any one of multiple removable media having recorded computer-readable instructions, including magnetic floppy disks and CD-ROM storage discs. Other suitable program product storage devices can include magnetic tape and semiconductor memory chips. In this way, the processing steps necessary for operation in accordance with the invention can be embodied on a program product.

Alternatively, the program steps can be received into the operating memory 610 over the network 620. In the network method, the computer receives data including program steps into the memory 610 through the network interface 618 after network communication has been established over the network connection 622 by well-known methods that will be understood by those skilled in the art without further explanation. The program steps are then executed by the CPU 602 thereby comprising a computer process.

It should be understood that the devices 210, 215 and 220 of the network system 205 illustrated in FIG. 2 typically have a construction similar to that shown in FIG. 6, so that details described with respect to the FIG. 6 computer 600 will be understood to apply to all computers of the system 205. Alternatively, the devices 210, 215 and 220 can have an alternative construction, so long as the computer can communicate with the other computers illustrated in FIG. 2 and can support the functionality described herein.

The present invention has been described above in terms of a presently preferred embodiment so that an understanding of the present invention can be conveyed. There are, however, many configurations for software distribution systems not specifically described herein but with which the present invention is applicable. The present invention should therefore not be seen as limited to the particular embodiments described herein, but rather, it should be understood that the present invention has wide applicability with respect to downloading and transferring of software. All modifications, variations, or equivalent arrangements and implementations that are within the scope of the attached claims should therefore be considered within the scope of the invention.

We claim:

1. A method of distributing software over a computer network, comprising:
offering access to electronic content as an incentive for installing software on a client device;
receiving a network request from a client device to download the content to the client device;
verifying that the software is installed on the client device;
sending the requested content to the client device over the network if the software is installed on the client device.

2. A method as defined in claim 1, wherein offering electronic content as an incentive for installing software on a client device comprises serving a Web page that includes a mechanism for automatically requesting the content.

3. A method as defined in claim 2, wherein the mechanism comprises a selectable hyperlink that, when selected, causes the client device to transmit a network request for content.

4. A method as defined in claim 1, wherein verifying that software is loaded on the client device comprises sending an installer application to the client device, wherein the installer application executes on the client device and verifies that the software is loaded on the client device.

5. A method as defined in claim 4, wherein the installer application examines a registry on the client device for the presence of a registry key associated with the software.

6. A method as defined in claim 1, additionally comprising:
installing the software on the client device if the software is not loaded on the client device.

7. A method as defined in claim 6, wherein installing the software on the client device comprises sending a setup application to the client device, wherein the setup application can execute on the client device to cause the client device to download the software.

8. A method as defined in claim 1, wherein sending the requested content to the client device comprises streaming content to the client device.

9. A method as defined in claim 1, wherein sending the requested content to the client device comprises sending an electronic file to the client device.

10. A method as defined in claim 1, additionally comprising sending a configuration file to the client device, wherein the configuration file identifies a network location of the software and a network location of the content.

11. A method of obtaining software over a computer network, comprising:
receiving an offer to obtain electronic content as an incentive for installing software on a client device;
sending a request to a server device to obtain the electronic content;
granting permission to install the software on the client device on the condition that access to the electronic content is granted;
installing the software on the client device;
receiving access to the electronic content.

12. A method as defined in claim 11, wherein receiving an offer to obtain electronic content as an incentive for installing software on a client device comprises receiving a Web page that includes a link that can be selected to request the electronic content.

13. A method as defined in claim 12, wherein sending a request to a server device to obtain the electronic content comprises clicking on the link.

14. A method as defined in claim 11, additionally comprising downloading an installer application that executes on the client machine to verify that the software is installed on the client machine.

15. A method as defined in claim 14, wherein the installer application installs the software on the client device by causing the client device to download the software from a server device.

16. A method as defined in claim 11, additionally comprising creating a registry record in a registry of the client computer after installing the software on the client device, wherein the registry record indicates that the software is installed on the client device.

17. A method as defined in claim 11, wherein receiving access to the electronic content comprises receiving a stream of data from a server device.

18. A method as defined in claim 11, wherein receiving access to the electronic content comprises receiving an electronic file from a server device.

19. A program product for use in a computer device that executes program steps recorded in a computer-readable media to perform a method of distributing software over a computer network, the program product comprising:
a recordable media; and
computer-readable instructions recorded on the recordable media, comprising instructions executable by the computer to perform operations comprising:
examining a registry of a client device to determine whether a required software application is loaded on the client device;
prompting a user for permission to install the required software on the client device if it is determined that the required software is not yet installed on the client device;
downloading the required software from a server computer if the user grants permission to install the required software;
installing the required software on the client computer;
providing access to a server computer through which electronic content can be obtained as a result of the installation of the required software.

20. A system for distributing software over a computer network, the system comprising:
a memory in which instructions and data are stored; and
a processor, coupled to the memory, such that the processor receives the instructions stored in the memory and executes the instructions to perform operations comprising:
offering access to electronic content as an incentive for installing software on a client device;
receiving a request from a client device to download the content to the client device;
verifying that the software is installed on the client device;
sending the requested content to the client device if the required software is installed on the client device.

21. A program product for use in a computer device that executes program steps recorded in a computer-readable media to perform a method of distributing software over a computer network, the program product comprising:
a recordable media; and
computer-readable instructions recorded on the recordable media, comprising instructions executable by the computer to perform operations comprising:
offering access to electronic content as an incentive for installing software on a client device;
receiving a request from a client device to download the content to the client device;
verifying that the software is installed on the client device;
sending the requested content to the client device if the required software is installed on the client device.
